(19) United States
(12) Patent Application Publication
(10) Pub. No.: US 2015/0311937 A1
(43) Pub. Date: Oct. 29, 2015

(54) Sliding Front Cover Cases for Smart phone & Tablet

(71) Applicant: Jason Jin Chel Lee, Paramount, CA (US)

(72) Inventor: Jason Jin Chel Lee, Paramount, CA (US)

(73) Assignee: Jason Jin Chel Lee, Paramount, CA (US)

(21) Appl. No.: 14/187,095

(22) Filed: Apr. 23, 2014

(51) Int. Cl. H04B 1/3888; H04M 1/02; A45C 11/00

(52) U.S. Cl. CPC H04B 1/3888; A45C 11/00; H04M 1/0202; A45C 2011/002; A45C 2011/003

(57) ABSTRACT

The invention here is a new type of protective cases for the current smart phones and tablets in the market. It has a new concept of how the front structure of the case open and to be secured.

This invention is originated from the need of eliminating inconveniences of using current flip cases of smart phones and tablets in the market. By sliding the front cover back into the device, it is more convenient to use. One can easily open the front cover with one hand and secure it. It also eliminates the space that need to flip the front covers around devices. It also secures the front cover better and gives more protection.

However, the front cover should be flexible enough to go around the case, and it can be made of various materials that are flexible. The front cover can either contain a transparent area, or can be made of transparent material all together. To function properly, it has to be flexible enough to go around the device.

The contact point a user can hold the front cover to slide it open could come in different shapes and sizes. It can be protruding small area that a user can grab easily, or a small receded area where a user can put finger tip into. Whatever the shape might be, a user should be able to use this part to operate the front cover of the case.

In conclusion, this invention is make the current users of smart phones and tablets cases more convenient to use. It also allows to secure the front covers better and protects from various elements such as dirt or liquid.

### CROSS REFERENCE TO RELATED APPLICATIONS

Not Applicable.

### STATEMENT REGARDING FEDERALLY SPONSORED RESEARCH

### Not Applicable.

### BACKGROUND OF THE INVENTION

The current cases of smart phone and tablet in the market are based on the concept of flipping the covers over and around of the device. This involves and uses more space, and it causes a degree of inconvenience. This invention is originated to eliminate or to reduce these two issues. The invention also provides better security and protection of front cover.

### SUMMARY OF THE INVENTION

The main concept of the invention here is to make the cases of phone and tablet more convenient to use and operate. By sliding the front cover into the case eliminates the required space the current cases to swing open. It also is more convenient to operate as one can just slide the front cover, using just one hand for example. It also secures the front cover better by eliminating the possibility of moving the front cover around device back and forth, and it protects the front cover better from elements by storing it within the case.

### DESCRIPTION OF THE DRAWINGS

(1) FIG. 1 through 3: The figures of 1, 2 and 3 show the front view of the cases in claim when a user holds and look from the view of front where the device goes in.

FIG. 1 shows the image when the front cover is most opened. The front cover is well inside of the case, and only small portion of it shows as shaded area (2).

FIG. 2 shows the image of the front cover when the front cover is half way opened.

FIG. 3 shows the image of the shaded front cover completely closed. The device is supposed to be completely secured inside of the claimed case and not shown.

(2) FIG. 4 through 6: The figures of 4, 5 and 6 show the cross sectional view of the cases in claim; as if the case has been cut in half horizontally and viewed from that angle.

FIG. 4 shows the image of cross sectional view of the FIG. 1, when the front cover is most opened.

FIG. 5 shows the image of cross sectional view of the FIG. 2, when the front cover is half way opened.

FIG. 6 shows the image of cross sectional view of the FIG. 3, when the front cover is completely closed.

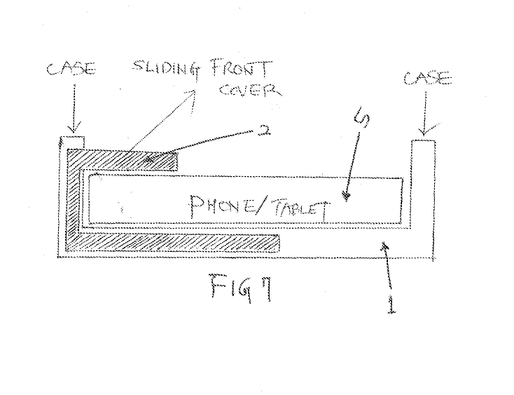

(3) FIG. 7: The FIG. 7 shows the cross sectional view of the case as if the case has been cut in half when the front cover is about one third closed. It is a more or less enlarged version of FIG. 5 to show better where the device goes in and how the case works.

(4) The Numbers in the figures:

1. This is the main body of the case consisting of top, bottom, both sides and the back of the case. This is where it provides structural openings that allow the front cover (2) to move in and out of. It also provides the complete structural integrity.

2. This is the front cover that is flexible to go inside of the case; yet it is capable of providing sufficient protection for the device from various elements. A portion or all of this area can be made of transparent material such as plastic, currently known as “S View” in the market.

3. This is the recommended contact point where users to hold or push the front cover in and out of the case. Although it is possible that users can touch any part of the front case to operate, this is the point with most convenience to operate the front cover of the case. This can be structurally modified to hold onto or grab by the users with more efficiency; a small protruding part or a little hold where users can stick their fingers in partially.

5. This is the appropriate device such as a smart phone or tablet that is going into the case claimed here.

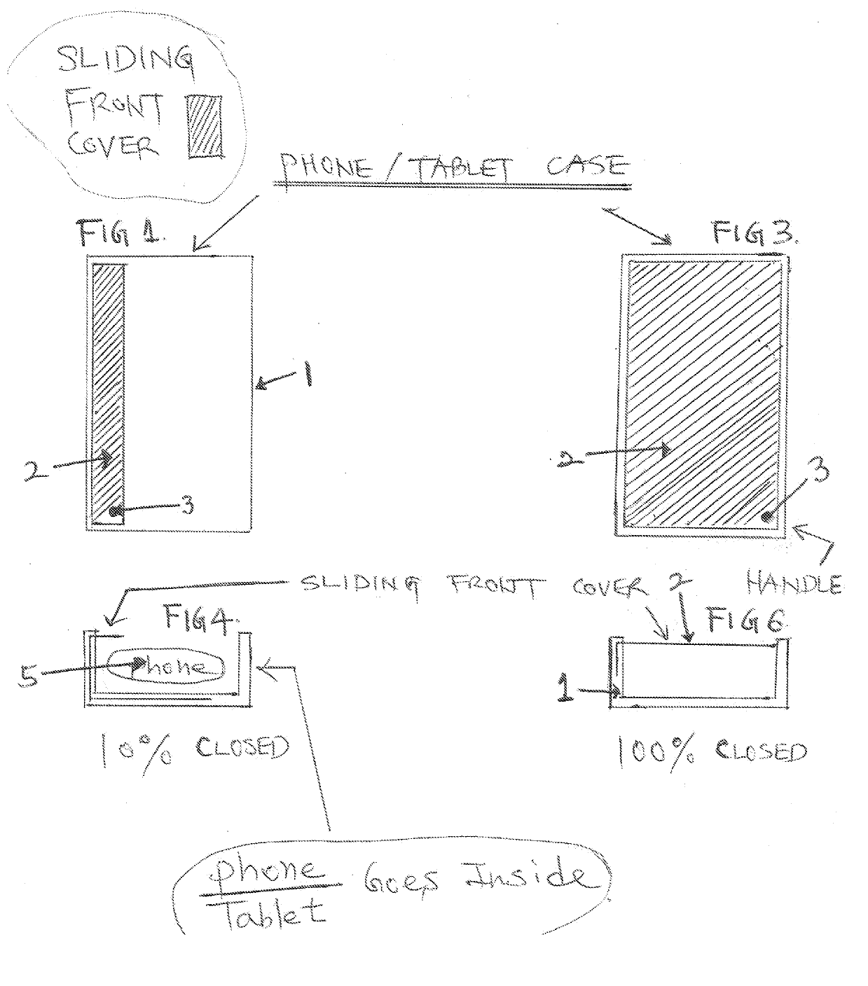

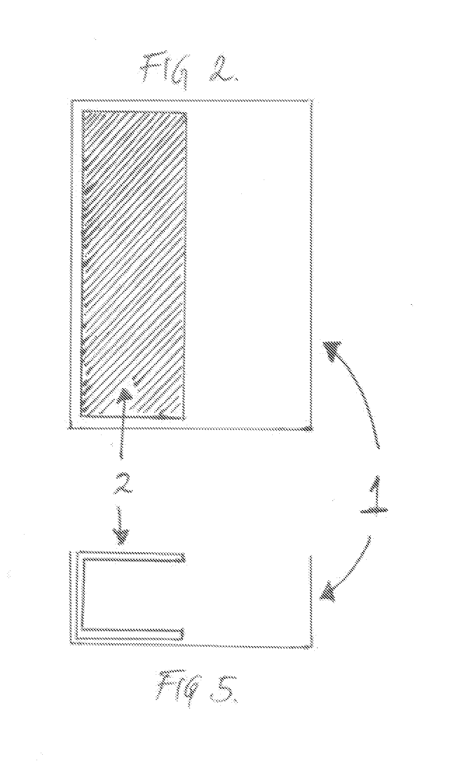

The drawings of the invention show that the front cover (2) of phone or tablet case (1) is able to slide in and out of the case (1). The phone or tablet (5) is sitting well inside of the case (1) to receive the full coverage and protection of the case (1). Sliding Front Cover (2) is either made of material that is flexible enough or has the structure that can be curved enough when it does slide in and out of the holding cases (1). The rest of the case (1) is rigid enough to maintain the overall structure and protection. On the right bottom (FIG. 1-3), there is a button or a part protruding (3) to function as a button or holding point a user can grab to move the front cover (2) in and out of the case (1). The button or holding point (3) can be vary in shape, size and location of the case. The movable front cover (2) can also be made of different material with different shape as long as it can provide the reasonable flexibility it requires as a movable and bendable cover (2). It can also contain an area of transparent, so called “S View”, that is common in many cases in the current market.

### DETAILED DESCRIPTION OF THE INVENTION

A general explanation of the invention and how to practice it: The drawings of the invention show that the front cover of the case of phone or tablet is able to go in and out of the case. Sliding Front Cover is either made of material that flexible enough or has the structure that can be curved enough when it does slide in and out of the holding case. By allowing the front cover to slide inside of the case, the case gives a number of advantages over the many cases in the current market. It eliminates the required space to open and to close the case. It also holds and secures the cover inside of case which provides better security and protection.

Specific examples of how to practice the invention: Convenience is among the foremost valuable advantage one might get from using this case. A user can use one hand to hold and operate the case, allowing the other hand to do other various tasks. For an example, one can keep holding and reading a book when she or he gets a phone call; she or he does not have to put the book down to pick up the phone, to slide open the case, and answer the phone. These actions can be completed by just one hand easily using the front cover sliding case. Time after time, when a user try to open the flip cases and secure the front cover, it takes two or three steps to get it done whereas with this new sliding case can be done by one simple step.

By storing the front cover inside back of the phone or tablet, it secures and protects the front cover more efficiently. When the cover flipped around the case, it is exposed to various elements. The cover can pick up dirt when placed on a dirty surface, or it can get wet or damaged if it is place on a wet surface or held by dirty hands. The contaminated area would go touch the screen when the front cover closes, and it might eventually affect the user's face when she or he use the phone or tablet next time. Because the front cover is secured firmly, it would not flip close accidently or when the holding unit, that hold the cover to the back, become lose.

### SEQUENCE LISTING

Not Applicable.

### CONCLUSION

This invention is to give the current users of smart phones and tablets cases more conveniences to use. It also allows to secure the front covers better and protects from various elements such as dirt or liquid damage.

Having described my invention here, I claim (one claim only):

1. Protective cases for smart phones & tablets with following structural features:
firm back, sides, top and bottom structures;
flexible front cover that goes around the device and into the case;
structural space that allows the front cover go inside of the case and secured;
and a partial or complete transparent flexible front cover.
